(19) United States
(12) Patent Application Publication
(10) Pub. No.: US 2011/0106550 A1
(43) Pub. Date: May 5, 2011

(54) RESUME AND CV CERTIFICATION PROCESS

(76) Inventor: Donald H. Skelton, Bonita Springs, FL (US)

(21) Appl. No.: 12/610,721

(22) Filed: Nov. 2, 2009

(51) Int. Cl. G06Q 99/00; G06F 17/30

(52) U.S. Cl. 705/1.1; 707/827; 707/E17.01; 707/E17.032

(57) ABSTRACT

A process of resume certification is provided. The process includes receiving a resume from an individual and submitting the resume to a baseline certification to produce a baseline certified resume. The process further includes storing the baseline certified resume in a baseline candidate database. The process includes charging the individual for the baseline certification and storage within the baseline candidate database. The process further includes accepting potential candidate requirements from prospective employers and identifying resumes belonging to relevant candidates from the baseline candidate database. Finally, the process provides the prospective employers with the resumes of such relevant candidates in combination with the baseline certification.

### TECHNICAL FIELD

The present invention relates generally to a method of servicing employers and job applicants by way of a resume service and more particularly to a method of a cost effective pre-certified resume database service to employers and job applicants. The present invention relates to pre certification of resumes in order to prevent potential applicants for employment from either embellishing or manufacturing information on their resumes.

### BACKGROUND OF THE INVENTION

The advancement of industry technology has generated an ever increasing need within corporations and private employers for employees with highly specific skills and backgrounds. This, in turn, has resulted in complex and costly process of interviewing and reviewing job applicants. Commonly, a corporation and/or private employer must review a large number of resumes to isolate candidates with the right background for a particular position. The resulting candidates are then interviewed and examined to find the most suitable matches. Due to errors and misleading statements on resumes, the candidates are often submitted to an investigation to verify the pertinent aspects of their background. These investigation can be extremely costly. In addition, they are often performed after considerable time and cost has been expended by the corporation in isolating the best potential candidates. These processes are extremely inefficient an non-cost effective for both potential employee as well as employer.

It is known that a significant percentage of resumes may contain information that is factually incorrect. While often the mistakes are insignificant, it is important that potential employers have confidence in the accuracy of their contents. Human resource officers can spend an enormous amount of time sifting through resumes to select candidates for positions within their company. After the applicant gets through the interview and is selected the HRO then conducts a background check before the candidate becomes employed by the company. A large number of man hours are typically invented in a potential candidate before the background process even begins.

A corporation and/or private employer could engage a certification company to review all submitted resumes prior to the interview process. This, however, is known to be extremely costly as well. In this scenario each of the resumes submitted for a position would incur a certification cost. Thus the employer would be paying to verify a large number of resumes whose candidates may likely be dismissed in early reviews. In addition, received resumes often comprise a wide variety of information having differing certification difficulties. Therefore, certification of batches of resumes cannot be accomplished in a uniform manner. The cost to most corporations and/or private employers, outside of secure government positions, renders this methodology impractical.

Finally, the information on a candidates resume that is vital may significantly vary depending on the particular employer or even the particular position to be filled. A particular employer or position may require applicant details that are unique or uncommon from a standard resume. While some employers may require extensive verification of every detail, certain employers may have simpler requirements such as a high school diploma. It would be highly efficient to utilize a flexible system that did not incur verification costs except when necessary.

It is therefore the intent of the present invention to provide a resume certification process that would pre-certify an individual's resume so as to provide to employers a candidate's resume that can be relied on as accurate. The process provides a unique and efficient service that pre certifies resumes to weed out resumes that are either embellished or fraudulent. The process will be accomplished in a large part through an electronic process that will be much more efficient than a HRO sifting through resumes and interviewing candidates who may have resumes containing inaccurate or misleading information. It is a further intention of the present invention to provide an online database of resumes that are pre-certified as correct so as to pair employee needs to prospective applicants who are qualified to address these needs. This provides a significant advantage to both candidate as well as employer.

### SUMMARY OF THE INVENTION

In accordance with the objects of the present invention, a process of resume certification is provided. The process includes receiving a resume from an individual and submitting the resume to a baseline certification to produce a baseline certified resume. The process further includes storing the baseline certified resume in a baseline candidate database. The process includes charging the individual for the baseline certification and storage within the baseline candidate database. The process further includes accepting potential candidate requirements from prospective employers and identifying resumes belonging to relevant candidates from the baseline candidate database. Finally, the process provides the prospective employers with the resumes of such relevant candidates in combination with the baseline certification.

The present invention further provides generating employer defined additional certification categories. The process identifies potential positions or employees requiring the additional certification categories. Finally the process allows individuals to pay for additional certification of the additional certification categories to have their resumes moved from the baseline candidate database to a tailored candidate database. The process further includes accepting potential candidate requirements from prospective employers and identifying resumes belonging to relevant candidates from the tailored candidate database. Finally, the process provides the prospective employers with the resumes of such relevant candidates in combination with the additional and baseline certification.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is an illustration of an embodiment of a process of resume certification in accordance with the present invention.

FIG. 2 is a detail illustrating the resume shown in FIG. 1.

FIG. 3 is a detail illustrating a baseline certification directed towards education for use in the process illustrated in FIG. 1.

FIG. 4 is a detail illustrating a baseline certification directed towards professional experience for use in the process illustrated in FIG. 1.

FIG. 5 is a detail illustrating a baseline certification directed towards professional certification for use in the process illustrated in FIG. 1.

FIG. 6 is a detail of the process in FIG. 1 illustrating additional steps.

FIG. 7 is an alternate embodiment of the detail illustrated in FIG. 6.

FIG. 8 is an alternate embodiment of the detail illustrated in FIG. 6.

FIG. 9 is an alternate embodiment of the detail illustrated in FIG. 6.

### DESCRIPTION OF PREFERRED EMBODIMENTS

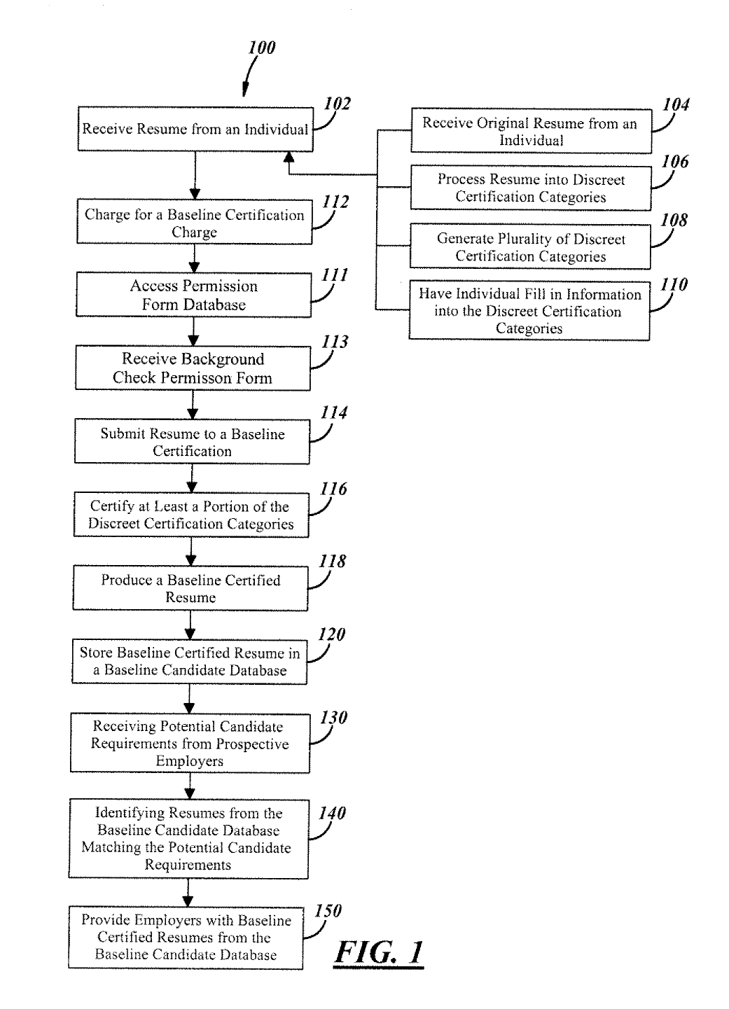

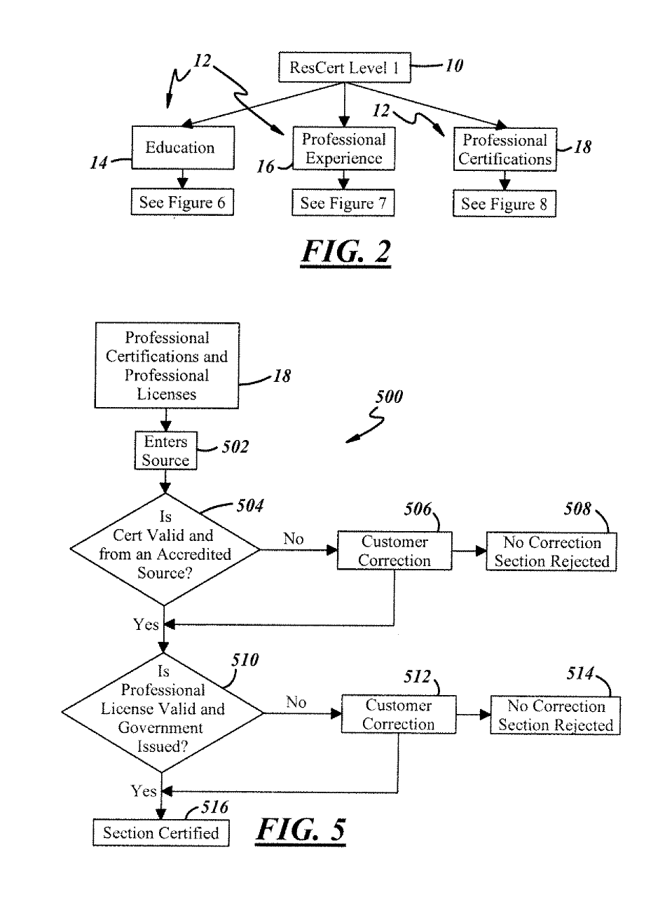

Referring now to FIG. 1, which is an embodiment of a resume certification process 100 in accordance with the present invention. The process 100 is comprised of receiving a resume from an individual 102. It is contemplated that this may be comprised of receiving a complete resume from an individual 104 and processing said resume into discreet certification categories 106. In addition, it is contemplated that this may be comprised of generating a plurality of discreet certification categories 108 and having an individual fill in said discreet certification categories 110. The second methodology is efficiently adaptable to online submission of resumes by individuals. In the basic operation of the aforementioned process a candidate will order the services via a webpage designed for the present unique process. The candidate will submit a resume 10 by filling-in the necessary fields or certification categories 12 provided by the software. (see FIG. 2) It should be understood that it is contemplated that all discreet certification categories need not be actually certified during the claimed process. Furthermore, it is contemplated that the discreet certification categories 12 may encompass a wide variety of resume categories such as name, address, educational history, job history, professional certifications, licenses, skills, criminal history, security clearances and a variety of other categories to name just a few. The process specific to a few sample discreet categories 12 such as education 14, professional experience 16, and professional certifications 18 is disclosed in more detail, although the substance of these processes may be applicable to any of the potential discreet categories 12.

Once the individual's resume 10 has been received, the process charges the individual, or a company, with a baseline certification charge 112 and submits the resume 10 to a baseline certification 114 (FIG. 1). This is preferably accomplished through the use of a credit card or debit card online. It should be understood that the baseline certification 114 is intended to encompass a wide variety of official verifications including, but not limited to, polling known or generated databases, phone inquiries, credit checks, government records and other investigative measures. The baseline certification is intended to officially certify at least a portion of the discreet certification categories 116. It is intended that the baseline certification covers the standard basics required by most companies such as educational and employment history. By generating a baseline certification 114 the present process provides a cost effective certification that satisfies the vast majority of employers and applicants. In at least one embodiment, the baseline certification all of the certification categories 12 presented to the applicant by the website.

It is further contemplated that the present invention require the submission of a background check permission form 113 prior to beginning any certification proceedings 114. This includes but is not limited to permission to check education and employment history. The present invention contemplates developing and accessing a permission form database 111 such that the required language or verbiage of a particular institution may be included if necessary. The present invention automatically matches the entered school or corporation with required verbiage and incorporates it into the background check permission form 113. This insures a quick and reliable confirmation process that allows individual institutions to retain a level of privacy release that they are already accustomed to. In addition, as individual institutional requirements are discovered and added to the database, they will be automatically be applied to the permission form of future candidates associated with the same institution.

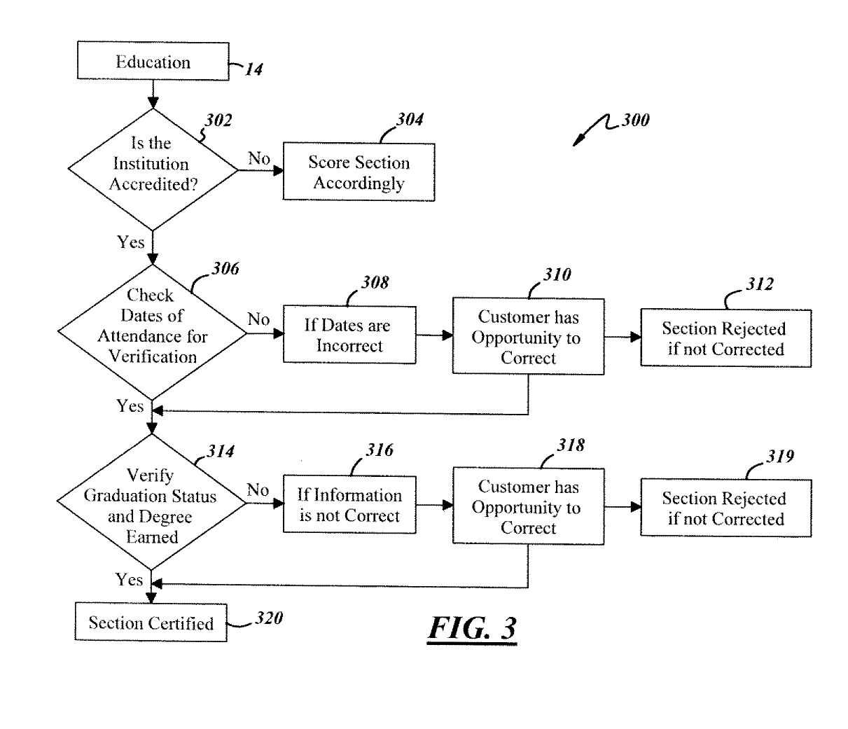

Although the present invention contemplates a variety of certification methodologies that may vary depending on the discreet certification categories 12 a few specific process are provided in more detail. FIG. 3 is an illustration of an embodiment of the certification methodology as it applies to education 300. The first educational certification step will be to determine if the educational institution is in fact a legitimate institution accredited by the US Department of Education 302. If the educational institution is accredited or non-accredited it will be scored accordingly 304. Scoring is utilized such that non-accredited institutions or non-verified institutions may still be certified but will be noted as such. In one embodiment it is contemplated that the scoring comprises reducing a percentage of reliability to a percentage such as 80% to indicate that the school in non-accredited. In other embodiments, a notation of non-accreditation will be applied. The verification of accreditation of high schools will be preferably accomplished through the use of an in house database of listed institutions. Verification of post secondary education will be electronically checked with the US Department of Education. In instances where the candidate has not earned a degree from a traditional secondary institution but has received a GED, the process electronically checks with the appropriate state agency to verify the information.

The electronic verification of accreditation is followed by a certification of attendance verification 306 to verify the dates of attendance. This is preferably accomplished electronically through a student clearinghouse database where possible. An in-house electronic system is utilized to contact institutions not on record with the student clearinghouse to certify attendance at the respective institutions. In at least one embodiment this constitutes electronically contacting the institution with the request in combination with the permission form. The certification checks the dates of attendance 308 to error and if found notifies the candidate electronically that there are inaccuracies in the aforementioned section and provides an opportunity to correct and resubmit the section for certification 310. If the information is not corrected the section is rejected 312 and the resume or section will not receive certification. In at least one model of the present invention the candidate is charged a surcharge to correct the certification. In another model, if the inaccuracies are weighted and if found sufficiently minor will prompt the candidate with the correct information. Thus if it is clear that attendance is only a month off or if an error is clearly typographical, the candidate is allowed to correct without surcharge.

After verification of attendance 306 is finished, the graduation and degree earned information listed on the resume are verified for accuracy 314. Where internal or external databases are electronically available they are utilized. Where institutions only release data with permission the institution is contacted electronically with the appropriate permission form. If the graduation status and/or degree are not correct 316 the candidate is notified electronically of the inaccuracies and given the opportunity to make corrections and resubmit the section for verification 318. If the information is not corrected the section is rejected 318 and the section/resume will not obtain certification 319. If all the information in the educational certification 300 is accurate the educational section will be certified as accurate 320.

In addition to the certification of education 300, the present invention contemplates a process for the certification of employment history 400 as shown in FIG. 4. The process includes utilizing a unique Employer Legitimacy Matric (ELM) 402 to help prevent the possibility of fabricated work history or the attempt to cover up potential gaps in employment. The contemplated unique matrix preferably has a unique 3 point checklist to determine if the company listed is legitimate 404. The checklist includes checking if the company has a phone number matching the address listed, a secretary of state listing, or a web domain. In one embodiment, the company is given a pass/fail score if any of the three checkpoints are satisfied 406. It is contemplated, however, that a company that fails all three checkpoints may be adjusted by the candidate to a passing status by submission of a W-2 or paystub from the company 408 to ensure its legitimacy. In another embodiment is the company satisfies all three checkpoints the company is assigned a score of 100% 406. If the company scores less than all three checkpoints, the score is reduced accordingly. In this embodiment, it is contemplated, however, that scores less than 100% may be adjusted by the candidate to 100% by submission of a W-2 or paystub from the company 408 to ensure its legitimacy. In this embodiment, where the company is a small operation or is not in operation and the candidate fails to provided a W-2 or paystub an employer score will be attached to the employment selection reflecting the reliability 410.

Once the company is checked through the ELM 402, the process electronically contacts the human resource office of the employer 412. The process confirms the legitimate identity of the human resource office by verifying legitimate company email address, fax number, or telephone number 413. The process further confirms that only current employees of the listed company responsible for handling HRO duties will be acceptable to complete certification of this section. This prevents the use of prior co-workers to act as fronts for the human resource department. The process utilizes internal and external databases to verify proper HRO contact. If the HRO information is not verified the candidate is afforded an opportunity to correct the data and resubmit for certification 415. If the data is not confirmed then the section/resume is not certified 417.

Where a company is no longer available, the company will be scored using the employer legitimacy matrix 402 to determine if the company was operating during the time period that candidate listed. The human resource office contact 412 will then be an officer of the corporation filed with the respective secretary of state records. In this ease web domain may be removed from the matrix of verification. The requirement of checking with a legitimate human resource officer 412 prevents the fabrication of contacts at past employers who are now defunct.

In either case, the human resource office contact will electronically verify that the candidate has correctly listed dates of employment, job duties, job salary, and Accomplishments accurately 414. It should be understood that the aforementioned list for verification may be modified as would be understood by one skilled in the art in light of this specification. If any of the elements are not correct 419 the candidate will be electronically notified and will have an opportunity to make corrections and resubmit for certification 416. If the information is not corrected the section is rejected and the section/resume will not receive certification 421. If, however, the information can be verified the employment section is certified 418.

It is contemplated that some candidates may have military experience listed within the employment section that require a unique method of verification. The military commonly protects such records closely and makes outside receipt difficult. Therefore the present invention contemplates a two step process of requiring the candidate to supply a copy of their discharge papers to verify dates of service, military branch and rank, and discharge status 420. In addition the candidate must sign a form acknowledging the penalties for falsifying military records.

In a certification method similar to the ones above, the present invention contemplates a unique method of verifying professional certifications 500 (FIG. 5). The candidate electronically enters the professional certification or license possesses in addition to the source where the certification or license was obtained 502. The process then determines of the professional certification/license is from an accredited source 504. It is contemplated that the determination of an accredited source 504 is electronically verified using a clearinghouse database or internal records. If the verification cannot be obtained with the clearinghouse or internal database, the customer supplied accreditation source is contacted for verification. If the accreditation cannot be verified the candidate may correct the information and resubmit for certification 506. If the information is not corrected the section/resume is rejected 508 and not certified.

If the professional license is obtained through state agencies it will be verified electronically through the respective state agency that granted the license 510. The status of the professional license and dates obtained will be verified. If any elements are not accurate the candidate will be electronically contacted 512 to correct the data and resubmit for certification. If corrected data is not obtained the section/resume is not certified 514. If the new data is confirmed the section is certified 516.

It is further contemplated that the present invention may include a section for personal accomplishments including membership in organizations. It is contemplated that similar to the above, the candidate will be submit valid contact information for the organization that can be verified as legitimate through a web based source or listed phone number in an identical fashion to the above.

If all sections are verified the resume may be certified as accurate in its entirety. The present invention, however, contemplates that resumes often include special skills or other details that are not readily verifiable through an accredited source. These may include skills such as typing and foreign language mastery for example. The present invention contemplates allowing the candidate to include the certifiable and non-certifiable information into an assortment of resume templates such that a resume with a professional appearance is generated. It is contemplated that the non-certifiable sections will be reflected as such on the final resume. In addition, the present invention contemplates that full certification of all sections may not always be desirable and therefore contemplates utilizing the aforementioned verifications in the following process.

The present invention utilizes the baseline certification 114 to produce a baseline certified resume 118 (FIG. 1). It is contemplated that the baseline certified resume may be comprised of a resume containing only verified information or an resume with verified and unverified information. It the second case, it is contemplated that the baseline certified resume 118 clearly identifies the verified information (such as by symbol, highlighting, etc.) as separate from the non-certified categories. The present invention then contemplates storing the baseline certified resume in a baseline candidate database 120.

In one embodiment it is contemplated that the resumes stored in the baseline candidate database may simply be sent to potential employers at the behest of applicants as an official resume that relieves the employer of the necessary background checks and instills confidence in the information presented. In another embodiment, however, it is contemplated that the process accepts potential candidate requirements for prospective employers 130. The process then identifies baseline certified resumes from the baseline candidate database having verified information matching the potential candidate requirements 140. The process then provides the prospective employers with the identified baseline certified resumes 150. This allows the prospective employers to be provided with a list of candidates that not only meet their requirements but have had those requirements pre-verified as accurate. This both increases the value of the candidates resume as well as significantly reduces employer time and cost.

The present invention contemplates that resumes and employment requirements vary quite significantly, beyond the baseline basics, depending on career, profession, employer and even specific positions within the employer. It is therefore contemplated that a range of detailed certification is desirable for both efficiency and cost. A janitorial position may only truly require high school diploma verification as well as place of last employment. A defense contract position, however, may require verification of criminal history, post graduate education, accurate job history, and an accurate list of prior residences to facilitate the issuance of a security clearance. Furthermore, specific employers or positions may require details not found on common resumes such as bar admission or computer software certification.

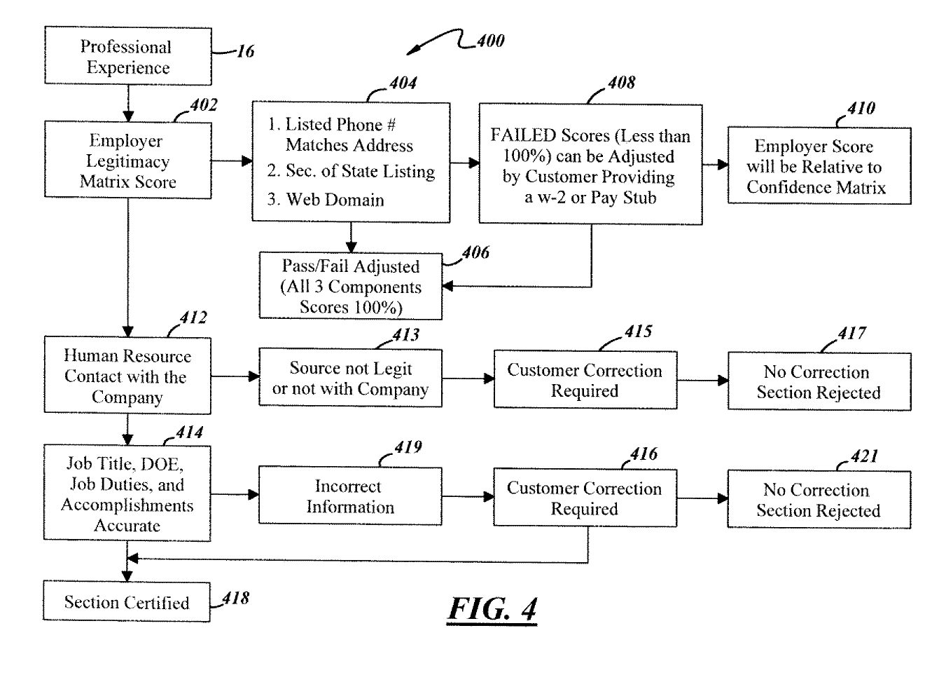

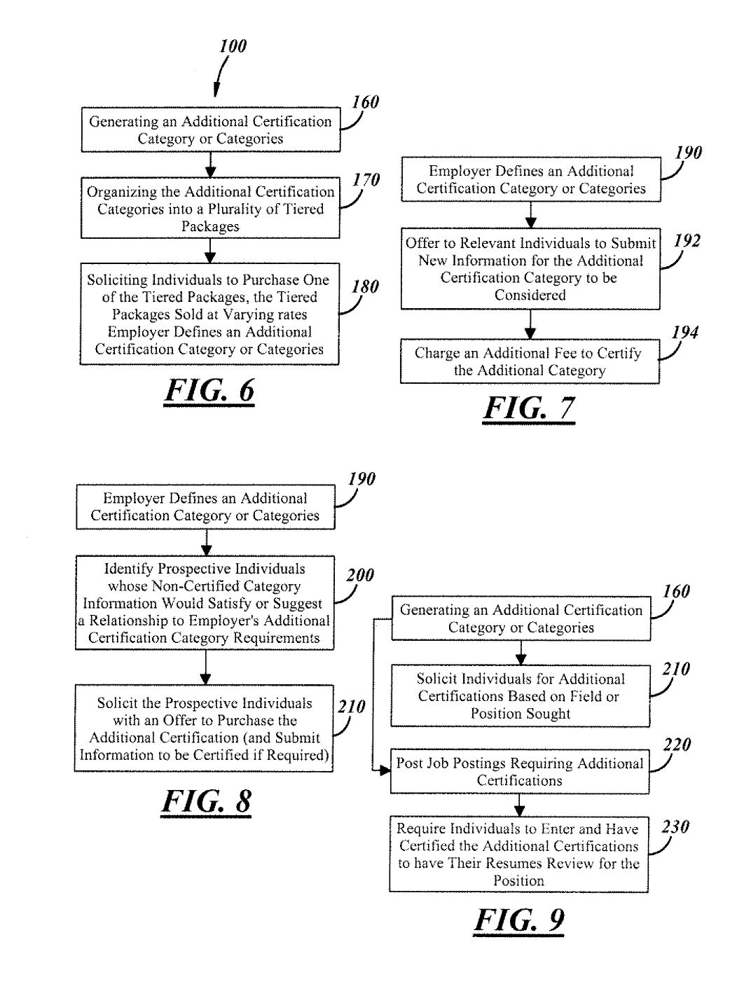

For these reasons, the present invention contemplates the generation of at least one additional certification category 160 or categories (See FIG. 6). These additional certification categories may comprise employer defined additional certification categories, field of employment designed additional certification categories, or position defined additional certification categories as discussed above. One embodiment contemplates organizing the additional certification categories into a plurality of tiered packages 170. The tiered packages are then sold to individuals at differing rates 180. In this fashion, a person new to the job force may not be required to pay as much as a twenty year physician's assistant. Similarly, employers will be dealing with a more tailored group of applicants inherently as the complexity of background increases. Although these additional certification categories may be pre-determined and offered on a tiered basis to individuals submitting resumes, there will likely be unique categories that are too specific to be dealt with in any common applicant basis. Familiarity with a particular brand of machining tool may be vital for one employer or position, but would not warrant inclusion in the central processing.

The present invention, therefore, contemplates that an employer may define an additional certification category 190 (See FIG. 7). The process then offers to relevant individuals to submit new information for the additional certification category to be considered (192). The individual is then charged an additional fee to certify the additional certification category (194). The identification of such individuals may be accomplished utilizing existing certified and non-certified categories that complement the additional certification category (such as general machining background for example). Alternatively, the process may simply identify prospective individuals whose non-certified category information would satisfy the employers additional certification category requirements 200. This may be accomplished by allowing individual generated categories or information during the entry process and searching these non-certified categories by keyword.

In either case, the present invention then contemplates approaching these prospective individuals with an offer to purchase the additional certification. 210 (FIG. 8). It is contemplated that this may be accomplished in a variety of fashions. In one embodiment, an individual would simply be solicited for additional certifications directed towards a particular field or position they seek. In another embodiment, job postings 220 could be posted and individuals would be required to enter and or have certified the additional certifications 230 in order to have their resumes reviewed for the position (FIG. 9). In this fashion, employers may require and receive verification of highly specific details thus far unknown in most resumes. The ability to not only identify these unique individuals from a mass database but to economically have verification of their unique abilities provides an advantage to both highly specialized employers and highly skilled employees alike.

Another feature of the present invention is contemplated to be a human resources organization clearinghouse database generated by the certified resumes submitted by candidates. The clearinghouse will enable employers to view the data on a secured website to ensure them that the resume has not been tampered with after certification. In one embodiment the potential employer will be given a resume number exclusive to the candidate's certified resume that will allow them access to the website. In another embodiment, the candidate will be given a personalized link that they can include on the resume they submit to an employer. By accessing the link on the web, the employer can again access the certified resume online to avoid tampering. This may also be accomplished by allowing the candidate to email the certified resume directly through the secured website hosted by the certification company. The email will give the potential employer access to the secured website to view the certified resume. Finally, it is contemplated that the candidate be given an encrypted image that when submitted to the secured website pulls up the certified resume. The encrypted image is preferably black and white in nature such that it can be contained on a printed resume, scanned in, and then utilized to access the secure website online.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A process of resume certification comprising:
receiving a resume from and individual;
processing information from said resume into discreet certification categories;
submitting said resume to a baseline certification;
certifying at least a portion of said discreet certification categories;
producing a baseline certified resume;
storing said baseline certified resume in a baseline candidate database; and
providing prospective employers with baseline certified resumes.

2. A process as described in claim 1, wherein receiving a resume from an individual comprising:
processing a resume into said discreet certification categories.

3. A process as described in claim 1, wherein receiving a resume from an individual comprising:
having said individual fill in said discreet certification categories.

4. A process as described in claim 1, further comprising:
receiving potential candidate requirements from said prospective employers; and
identifying baseline certified resumes from said baseline candidate data base having verified information matching said potential candidate requirements.

5. A process as described in claim 1, further comprising:
generating at least one additional certification category;
charging an additional fee to certify said additional certification category.

6. A process as described in claim 5, wherein said at least one additional certification category comprises a plurality of additional certification categories, the process further comprising:
organizing said additional certification categories into a plurality of tiered packages;
offering said plurality of tiered packages to said individual at varying rates.

7. A process as described in claim 5, further comprising:
identifying prospective individuals whose non-certified category information would satisfy said additional certification category requirements; and
soliciting said prospective individuals with an offer to purchase additional certification.

8. A process as described in claim 5, further comprising:
identifying prospective individuals whose non-certified or certified category information would relate to said additional certification category requirements;
soliciting said prospective individuals to submit new information for the additional certification category;
soliciting said prospective individuals with an offer to purchase additional certification for said additional certification category.

9. A process as described in claim 5, further comprising:
having an employer define said additional certification category.

10. A process as described in claim 5, further comprising:
soliciting said prospective individuals to submit new information for said additional certification category based on a particular job or position they seek.

11. A process as described in claim 5, further comprising:
posting a job opening in combination with said additional certification category; and
soliciting said prospective individuals to submit new information for the additional certification category in order to be considered for said job opening;
soliciting said prospective individuals with an offer to purchase additional certification for said additional certification category.

12. A process of resume certification comprising:
receiving a resume from and individual;
processing information from said resume into discreet certification categories;
submitting said resume to a baseline certification;
certifying at least a portion of said discreet certification categories;
generating at least one additional certification category;
charging an additional fee to certify said additional certification category;
producing a certified resume;
storing said certified resume in a certified candidate database; and
providing prospective employers with certified resumes.

13. A process as described in claim 12, wherein receiving a resume from an individual comprising:
processing a resume into said discreet certification categories.

14. A process as described in claim 12, wherein receiving a resume from an individual comprising:
having said individual fill in said discreet certification categories.

15. A process as described in claim 12, further comprising:
receiving potential candidate requirements from said prospective employers; and
identifying certified resumes from said certified candidate data base having verified information matching said potential candidate requirements.

16. A process as described in claim 12, wherein said at least one additional certification category comprises a plurality of additional certification categories, the process further comprising:
organizing said additional certification categories into a plurality of tiered packages;
offering said plurality of tiered packages to said individual at varying rates.

17. A process as described in claim 12, wherein said certified resume includes certified category information and non-certified category information.

18. A process as described in claim 17, A process as described in claim 12, further comprising:
identifying prospective individuals whose non-certified category information would satisfy said additional certification category requirements; and
soliciting said prospective individuals with an offer to purchase additional certification.

19. A process as described in claim 12, further comprising:
posting a job opening in combination with said additional certification category; and
soliciting said prospective individuals to submit new information for the additional certification category in order to be considered for said job opening;
soliciting said prospective individuals with an offer to purchase additional certification for said additional certification category.

20. A process of resume certification as described in claim 12, further comprising:
soliciting said prospective individuals to submit new information for said additional certification category based on a particular job or position they seek.

21. A process of resume certification comprising:
providing a candidate with a plurality of certification categories to be entered online;
submitting said resume to a certification, said certification comprising:
electronically verifying the legitimacy of an employer using a employer legitimacy matrix containing a plurality of individual checklist items;
applying an employer score using said employer legitimacy matrix;
electronically verifying the legitimacy of a human resource contact at said employer;
electronically verifying the candidate's employment information with said human resource contact;
repeating the certification for additional employers if necessary;
registering said resume as having an employment certified section if employer legitimacy, human resource contact legitimacy, and employment information are accurate.

22. A process as described in claim 21, wherein said employer score comprises a pass/fail score.

23. A process as described in claim 22, further comprising:
electronically contacting said candidate with unverified employment data with an offer to correct by submission of W-2 or paystub information; and
resubmitting the candidate correction for certification.

24. A process as described in claim 21, further comprising:
attaching the employer score to the certified section to reflect the reliability of the certification.

25. A process as described in claim 21, further comprising:
electronically contacting said candidate with unverified employment data with an offer to correct; and
resubmitting the candidate correction for certification.

26. A process as described in claim 21, wherein said certification further comprises:
electronically verifying the accreditation of an institution;
applying an institutional score based on said accreditation;
electronically verifying the candidate's dates of attendance with said institution;
electronically verifying the candidate's graduation status and degree with said institution;
repeating the certification for additional educational institutions if necessary;
registering said resume as having an education certified section if said institutional accreditation, said dates of attendance, and said graduation status and degree are accurate; and
electronically contacting said candidate with unverified educational data with an offer to correct; and
resubmitting the candidate correction for certification;
certifying said educational section if accurate.

27. A process as described in claim 21, wherein said certification further comprises:
electronically verifying the accreditation of a professional certification license source;
electronically verifying the candidate's certification/license status with said source;
repeating the certification for additional professional certification/license sources if necessary;
registering said resume as having an professional certification/license certified section if said professional certification/license source accreditation and said candidate's professional certification/license status are accurate; and
electronically contacting said candidate with unverified professional certification/license data with an offer to correct; and
resubmitting the candidate correction for certification;
certifying said professional certification/license section if accurate.

28. A process as described in claim 21, further comprising:
accessing a permission form database and providing said candidate with a background check permission form;
receiving a signed version of said background check permission form from said candidate; and
providing said background check permission form to sources during certification.

29. A process as described in claim 21, further comprising:
incorporating said certified section along with uncertified information into a resume template; and
indicating said certified information; and
providing a link to a clearing house database for employers to confirm certification.

30. A process as described in claim 29, wherein said link is a web link.

31. A process as described in claim 21, further comprising:
storing said candidate's resume in a resume clearinghouse; and
providing employers access to said resume clearinghouse.

32. A process as described in claim 31, further comprising:
allowing said candidate to email the certified resume directly through a secured website hosted by a certification company.
